(19) United States
(12) Patent Application Publication
(10) Pub. No.: US 2026/0102947 A1
(43) Pub. Date: Apr. 16, 2026

(54) SYSTEMS AND METHODS FOR PRODUCTION OF COLORED POST-CONSUMER RECYCLED COMPOUNDS

(71) Applicant: Ampacet Corporation, Tarrytown, NY (US)

(72) Inventors: Eli MARGALIT, Moshav Y'aad, Misgav (IL); Vadim REGELMAN, Kiryat Bialik (IL); Daniel HOFMANN, Haifa (IL); Gustavo LIDZKI, Rye Brook, NY (US)

(73) Assignee: Ampacet Corporation, Tarrytown, NY (US)

(21) Appl. No.: 19/352,203

(22) Filed: Oct. 7, 2025

Related U.S. Application Data
(60) Provisional application No. 63/705,949, filed on Oct. 10, 2024.

(51) Int. Cl. B29B 7/72; B01F 33/84; B01F 35/213; B01F 35/22; B01F 101/00; B29B 7/60; B29B 9/12; B29K 105/00; B29K 105/26; C08J 3/22; G01J 3/46

(52) U.S. Cl. CPC B29B 7/726; B01F 33/846; B01F 35/213; B01F 35/2202; B29B 7/603; B29B 9/12; C08J 3/22; G01J 3/462; B01F 2101/2805; B29K 2105/0032; B29K 2105/26; C08J 2300/30; G01J 2003/467

(57) ABSTRACT

Systems and methods for producing colored plastic compound using post-consumer recycled (PCR) plastics include a plurality of material feeders, each feeding a single component material of either PCR particles or mono-pigment masterbatch in accord with a pigment recipe formulated for producing a pelletized PCR compound with a target color. A control unit controls the material feeders in accord with the pigment recipe, while making real-time adjustments to the pigment recipe, and the corresponding control of the material feeders, based on spectral signals received from an inline spectrometer and a calculated color-deviation between coloration of PCR pellets output during an active production run and the intended target color.

### FIELD OF THE INVENTION

The present invention relates to systems and methods for producing colored units of post-consumer recycled (PCR) plastics, and in particular colored PCR pellets with substantially uniform coloration for subsequent use as colored PCR compound in the manufacturing of plastic products.

### BACKGROUND OF THE INVENTION

In plastics manufacturing, products are typically formed by feeding one or more polymers and one or more masterbatches into a processing machine (e.g., an injection molding, blow molding, extrusion machines) to produce a final plastic product. The polymer is a plastic material for formation of the plastic product and may also commonly be referred to as a “resin”, “raw material”, or “virgin”. The masterbatches are concentrated mixtures of pigments and/or additives that have been encapsulate in a carrier resin and pelletized. The polymer and masterbatches are fed in small particle forms that may be referred to interchangeably as “pellets”, “beads”, and “granules”, and which typically have a weight in a range of 0.01 g-0.04 g.

Conventionally, production of a colored plastic product is achieved by feeding the polymer together with a pigment masterbatch composed of a predetermined mixture of colorized pellets or powder pigments of varying colors. The composition of a given pigment masterbatch is based on a pigment recipe that dictates the percentages of the varying powder pigments or colorized pellets as needed for achieving a target color for a final plastic product, which is determined in advance based on the natural color of the polymer with which the pigment masterbatch is to be mixed for forming the plastic product. In other words, a pigment recipe provides a specific formula of various colors, and quantities of each, needed for adjusting the natural color of a specific polymer to achieve a target color for a final plastic product.

Current practices promote the use of post-consumer recycled (PCR) plastics in the manufacture of plastics products. PCR plastics are reprocessed plastics sourced from plastic waste (e.g., household, commercial, manufacturing refuse). The use of PCR plastics diverts waste from landfills, thereby reducing environmental waste, while also offering energy savings as the reprocessing of recycled plastics generally requires less energy than the production of virgin plastics. However, the use of PCR plastics presents new challenges, including difficulties in reliably achieving target colors.

Conventionally, PCR-based plastic products are formed by feeding a PCR compound as part of the polymer component together with a premixed pigment masterbatch, mixing the polymer and pigment masterbatch to form a homogenous mixture, and feeding the homogenous mixture to a processing machine for formation of a final plastic product. The PCR compound used in these processes are conventionally produced by a process such as that shown in FIG. 1, which generally includes: collecting plastic waste (S1), sorting and categorizing the collected waste materials (S2), shredding and washing the categorized waste materials to produce PCR particles (S3), melting and pelletizing the PCR particles (S4), and outputting PCR pellets for collection as a PCR compound (S5).

As the shredded PCR particles used for making the PCR compound are formed from recycled materials with a wide range of various colors, the pellets in the resulting PCR compound generally have a non-uniform grayish coloration, with individual pellets in a single batch of PCR compound having various shades of gray to black color. The non-uniform coloration of these PCR compounds complicates the manufacture of colored plastics products, as the pigment masterbatches used in manufacturing colored plastic products are premixed according to pigment recipes that are precisely formulated to achieve a target color based on the natural, base color of the specific polymer with which the pigment masterbatch is to be used. However, since the individual pellets in a PCR compound vary in color, these precisely formulated pigment masterbatches are then less effective in accurately and reliably achieving the target color, resulting in PCR-based plastic products often having color variations from one unit to another, or even within individual units.

Sophisticated manufacturers may attempt to reduce color variation in PCR-based plastic products by sorting a batch of PCR compound into separate pellet collections, with each pellet collection composed of PCR pellets of similar shades. Separate pigment masterbatches may then be used for each of the separate pellet collections, with each pigment masterbatch premixed based on a pigment recipe formulated for the shade of a specific pellet collection. However, there will continue to be variations of grayish coloration even within the individually sorted PCR pellet collections, such that there are continued color variations in the plastic products produced therefrom.

There thus remains a need in the art for further improving the reliability of accurately achieving target colors in the production of PCR-based plastics products.

### SUMMARY OF THE INVENTION

A system for production of colored post-consumer recycled (PCR) compound comprises a plurality of material feeders, each adapted for feeding metered quantities of a corresponding material; a control unit configured to control operation of the plurality of material feeders to feed the corresponding materials at predetermined feed rates in accord with a pigment recipe that is formulated for producing colored PCR compound of a target color from a number of mono-piment masterbatches; and a spectrometer in signal communication with the control unit for delivering spectral signals to the control unit informing on the color of colored PCR compound.

The control unit is configured to calculate a color-deviation between the color of the colored PCR compound and a target color associated with a pigment recipe that the control unit is using to control the material feeders for production of colored PCR compound, and to determine if the calculated color-deviation exceeds a predetermined color-deviation threshold. If the calculated color-deviation exceeds the color-deviation threshold, calculate a color correction for adjusting the pigment recipe to alter feed rates of one or more of the plurality of material feeders to reduce the calculated color-deviation, adjust the pigment recipe in accord with the calculated color correction, and proceed with control of the material feeders in accord with the adjusted pigment recipe. If the calculated color-deviation does not exceed the color-deviation threshold, proceed with control of the material feeders without adjustment to the pigment recipe. Preferably, the control unit is configured to execute these if-then controls of the system in real-time, to repeatedly adjust a pigment recipe multiple times during a single production run for decreasing a calculated color-deviation each time the calculated color-deviation exceeds a predetermined color-deviation threshold.

The control unit may be further configured to control the material feeders in accord with a pigment recipe {C} that is formulated for producing the colored PCR compound from uncolored PCR particles, the control unit being configured to adjust the pigment recipe {C} in real-time based on a color correction (ΔC) that is calculated from spectral property differences between a best-fit pigment recipe for the target color {C0} that is formulated in advance based on a presumed baseline color for the uncolored PCR particles, and a resultant pigment recipe {C1} that is calculated in real-time based on spectral properties of color PCR compound produced according to the pigment recipe {C}.

The control unit may be further configured to control the material feeders for feeding predetermined quantities of PCR particles and a number of mono-pigment masterbatches into a processing machine for melting and pelletizing the combined materials to form colored PCR compound; and the spectrometer may be further configured to monitor spectral properties of PCR compound output from a processing machine that receives the combined materials for forming the colored PCR compound.

The processing machine may be further configured to receive the combined materials that are fed from the material feeders under control of the control unit, and to melt and pelletize the combined materials to form colored PCR pellets, and to output the colored PCR pellets for collection as a colored PCR compound. The spectrometer may be positioned proximate an outlet of the processing machine for assessing spectral properties of colored PCR pellets output from the processing machine, or along an offshoot that receives a diverted portion of the colored PCR pellets. The control unit may be further configured to receive a user input identifying a target color and to load a pigment recipe for producing a colored PCR compound with the target color.

The control unit may comprise a memory storing one or more pigment recipes, and the control unit loads the pigment recipe for producing the colored PCR compound with the target color by identifying a pigment recipe stored in the memory and associated with the target color. The memory may store L*a*b* color space data, and the control unit may be configured to load the pigment recipe for producing the colored PCR compound with the target color by calculating a pigment recipe for the target color using the stored L*a*b* color space data.

In use, the system may loading a pigment recipe for producing colored PCR compound with a target color that is selected by a user operating the system. The color and associated pigment recipe user may be loaded from a collection of colors and associated color recipes that are preloaded in a memory of the control unit, or may be loaded by scanning a reference sample having the desired color and reverse calculating a a pigment recipe for the scanned color using L*a*b* color space data stored in a memory of the control unit. The system then produces a PCR compound by feeding PCR particles from at least one material feeder and feeding one or more mono-pigment masterbatches from one or more further material feeders in accord with the pigment recipe.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a conventional process for producing a PCR compound.

FIG. 2 shows an example of a system according to the present invention.

FIG. 3A shows a flow-path schematic for single component feeds in the system in FIG. 2, when the system is configured as a continuous loss-in-weight gravimetric blending system.

FIG. 3B shows a flow-path schematic for single component feeds in the system in FIG. 2, when the system is configured as a gravimetric batch blending system.

FIG. 4 shows a schematic for a control unit in the system in FIG. 2.

FIG. 5 shows a close-up of the outlet of a processing machine in the system in FIG. 2.

FIG. 6 shows real-time monitoring of a color-deviation using the system in FIG. 2.

FIG. 7 shows a process for producing colored PCR compound using the system in FIG. 2.

### DETAILED DESCRIPTION OF THE INVENTION

The following disclosure discusses the present invention with reference to the examples shown in the accompanying drawings, though does not limit the invention to those examples.

The use of examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is inclusive of systems and methods for production of colored post-consumer recycled (PCR) pellets, and in particular colored PCR compounds for use in subsequent plastics manufacturing processes. Systems and methods according to the present invention use feedback from an inline spectrometer to make in-line corrections, according to the disclosed algorithm, to a pigment recipe for production of the colored PCR compound to reduce color-deviations within a batch of colored PCR compound in real-time during an active production run.

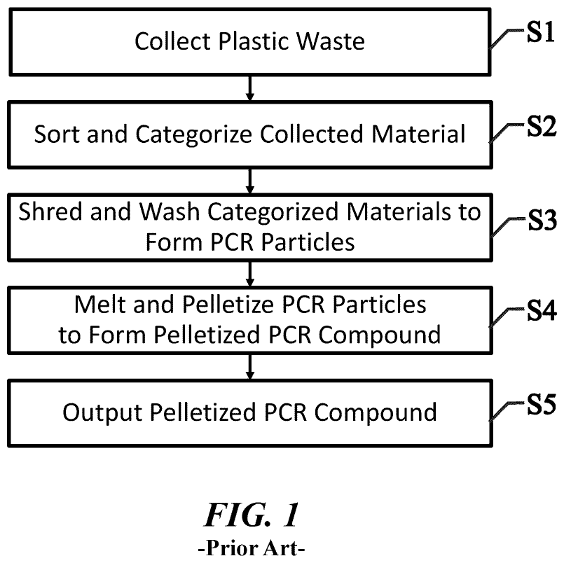

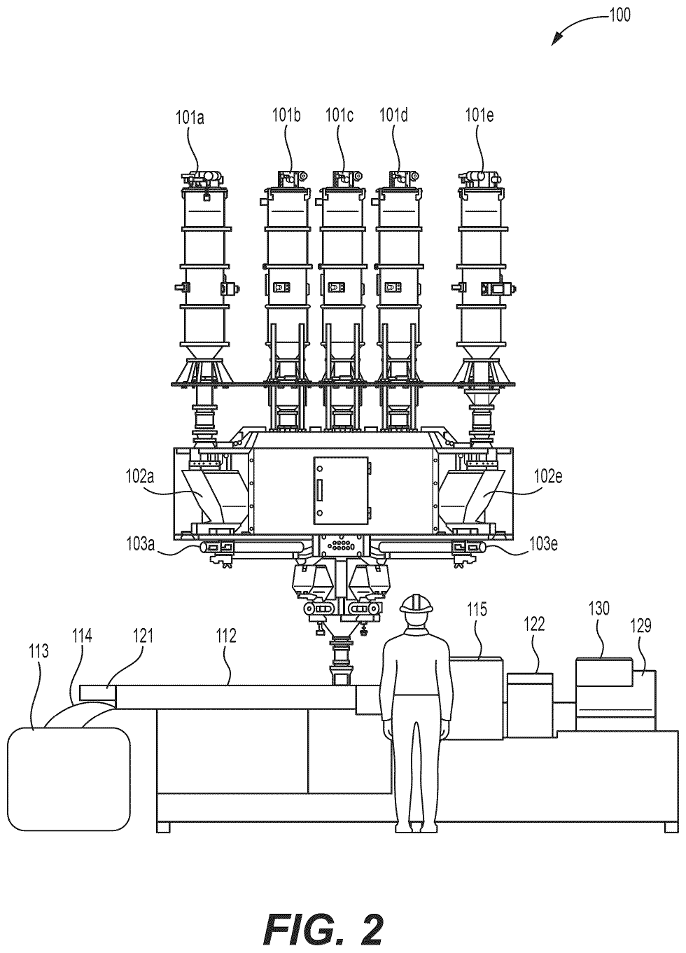

FIG. 2 shows an example of a system 100 according to the present invention, with a plurality of single-component supply sources 101a-101e, with at least one supply source 101a containing uncolored PCR particles (i.e., natural grayish or other coloration) and multiple other supply sources 101b-101e each containing a mono-masterbatch (i.e., a concentrated masterbatch of a single uniform color pigment, also referred to herein as a mono-pigment masterbatch). The PCR particles in the supply source 101a may have previously been obtained in accord with steps S1-S3 of the conventional process in FIG. 1, or any other suitable process.

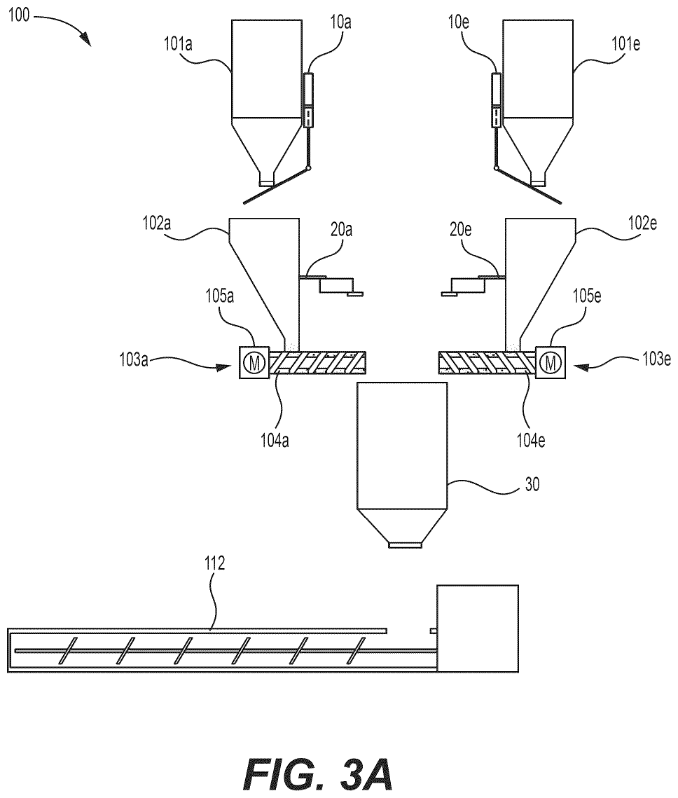

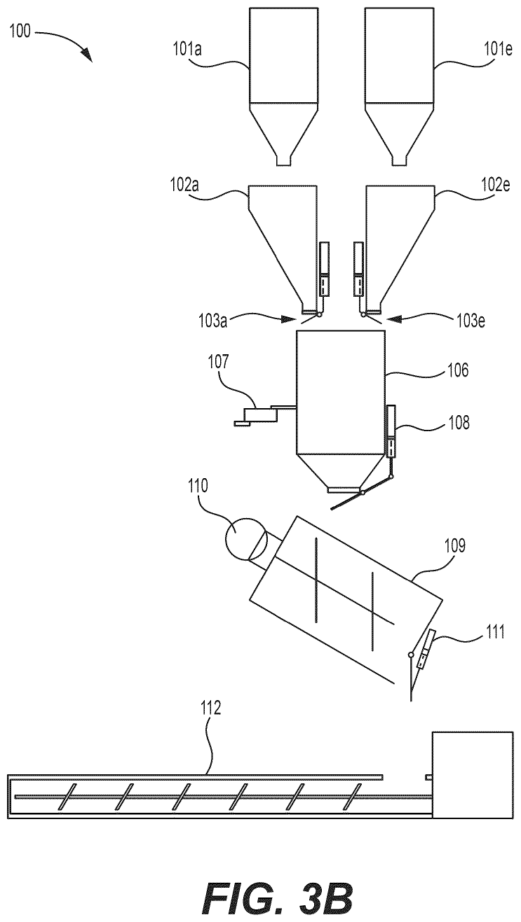

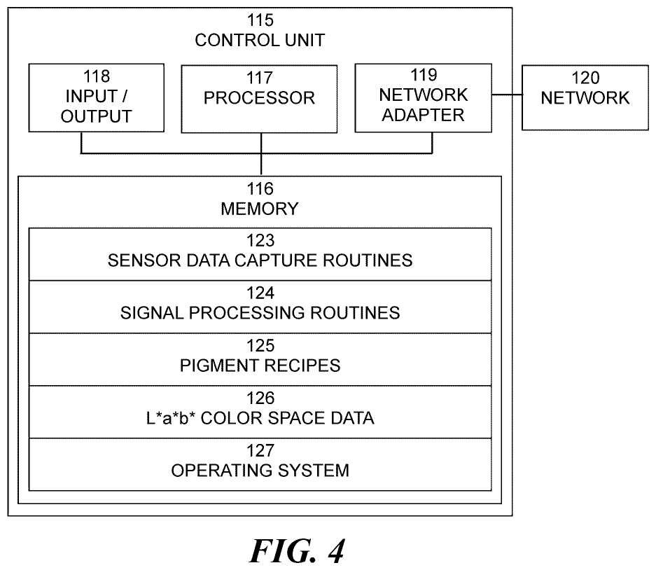

FIG. 3A shows a flow-path schematic for an example of the system 100 that is configured as a continuous loss-in-weight gravimetric blending system. Though this schematic shows representations for material flow only relative to material supply sources 101a and 101e, it will be understood that the same applies to the remaining supply sources 101b-101d. As seen in FIG. 3A, each supply source 101 is provided with a gate unit 10 for feeding metered doses of the corresponding material to a downstream material feeder 102. Each material feeder 102 is provided with a load cell 20 and a metered feeding mechanism 103 for feeding predetermined quantities of the material stored in the corresponding supply source 101 (e.g., PCR particles, mono-masterbatch, additives, etc.). The material feeders 102 may be any suitable type of material feeder depending on the nature of the system, with an appropriate feeding mechanism for the same. For example, material feeders 102 may be gravimetric feeders, volumetric feeders, liquid feeders, powder feeders, or any other suitable material feeder type; and feeding mechanisms 103 may be motor-driven feed screws, motor-driven conveyer belts, motor-driven vibratory channels, gate units, or any other suitable feeding mechanism. Each material feeder 103 is in material feed communication with a common funnel 30 that receives the combined metered material quantities from each material feeder 102 and directs the combined material feeds to the inlet of a processing machine 112 that extrudes and pelletizes the combined feeds to produce colorized PCR pellets that are output to a collection container 113 for storage as a batch of colorized PCR (C-PCR) compound 114. Optionally, the common funnel 30 may be omitted, and the feeding mechanisms 103 of the material feeders 102 may feed the respective material feeds directly into the inlet of the processing machine 112.

FIG. 3B shows a flow-path schematic for an example of the system 100 that is configured as a gravimetric batch blender system. Again, though this schematic shows representations for material flow only relative to material supply sources 101a and 101e, it will be understood that the same applies to the remaining supply sources 101b-101d. As seen in FIG. 3B, each supply source 101 feeds to a dedicated material feeder 102 that is adapted to feed predetermined quantities of the material stored in the corresponding supply source 101 (e.g., PCR particles, mono-masterbatch, additives, etc.). The material feeders 102 are adapted to feed precise quantities of material via inclusion of a metered feeding mechanism 103. Again, the material feeders 102 may be any suitable type of material feeder depending on the nature of the system, with an appropriate feeding mechanism for the same. For example, material feeders 102 may be, volumetric feeders, liquid feeders, powder feeders, or any other suitable material feeder type; and feeding mechanisms 103 may be motor-driven feed screws, motor-driven conveyer belts, motor-driven vibratory channels, gate units, or any other suitable feeding mechanism. Each material feeder 103 is in material feed communication with a common weighing receptacle 106 that is configured for receiving the combined metered material quantities from each material feeder 102. The weighing receptacle 106 has a load cell 107 for determining a combined weight of the metered materials received therein, and for triggering opening of a gate 108 to release the combined materials upon reaching a predetermined total weight. The weighing receptacle 106 is in material feed communication with a mixing chamber 109 that receives the combined metered materials from the weighing receptacle 106 and mixes the same to produce a homogeneous mixture of the PCR particles and the mono-masterbatches. The mixing chamber 109 is driven by a motor 110 and has a gate 111 that opens after sufficient mixing to feed the homogeneous mixture to a processing machine 112 that then extrudes and pelletizes the homogeneous mixture to produce colorized PCR pellets that are output to a collection container 113 for storage as a batch of colorized PCR (C-PCR) compound 114.

The processing machine 112 is an extruder that heats and melts the combined material feeds or homogenous mixture received therein to uniformly disperse the component materials in the production of a molten PCR product as a thoroughly mixed combination of the raw PCR particles and the mono-masterbatch components with homogenous and uniform color distribution throughout. The molten colored PCR product is extruded into strands, which are then cooled and cut into uniform pellets to produce a pelletized C-PCR compound product, which is then output to the collection container 113. It is preferrable that the processing machine 112 be a twin-screw extruder, as the use of intermeshing screws provides a favorably high shear and mixing efficiency for dispersing the pigments from the mono-masterbatches uniformly throughout the PCR material. The intermeshing screws are also expected to promote a more effective processing of the raw PCR materials, which often have variable viscosities and compositions. Optionally, the processing machine 112 may have multiple feeding inlets, allowing for the introduction of separate material feeds from the PCR particle feed and/or one or more of the mono-masterbatch feeds to be fed into the processing machine 112 at different 1. stages of the process, which may prove beneficial in promoting thorough processing and mixing of the material feeds.

A control unit 115 is provided with a memory 116 adapted for storing data, a processor 117 for reading and executing data stored at the memory 116, and input/output devices 118 for receiving and outputting data. Optionally, a network adapter 119 may also be provided to for communication with a network 120, for example, to enable remote updates to data and software stored at the memory 116. The input/output devices 118 include an inline spectrometer 121, a user interface 122 (such as a display screen, keyboard, touch screen display, etc.) and any other sensors that may be present in the system 100. Data stored at the memory 116 may include, though is not limited to, sensor data capture routines 123, signal processing routines 124, pigment recipes 125, L*a*b* color space data 126, and operational programming 127. Sensor data capture routines 123 include programming for receiving signals from the spectrometer 121, as well as any other sensors. Signal processing routines 124 include routines for processing received signals. Pigment recipes 125 include programming with formulations instructing the feeding of material components (e.g., PCR particles, mono-masterbatches, additives, etc.) for production of C-PCR compounds with specific target colors, and may include formulations preloaded in the memory 116, formulations calculated by the processor 117 from prior production runs, and formulations uploaded to the memory 116 (e.g., via user input or software updates). L*a*b* color space data 126 includes L*a*b* color space mapping coordinates and color correction algorithms for effecting color adjustments in L*a*b* color space coordinates for effecting changes in coloration of C-PCR compounds. Color correction algorithms may include correction algorithms preloaded in the memory 116, correction algorithms calculated by the processor 117 from prior production runs, and correction algorithms uploaded to the memory 116 (e.g., via user input or software updates). Operational programming 127 includes programming and operating systems for operation of the system 100 generally.

The inline spectrometer 121 is provided at an outlet of the processing machine 112 to assess the coloration of pellets in an output C-PCR compound 114 in real-time. The inline spectrometer 121 may be positioned within the main outlet of the processing machine 112 to inspect the melted mixture of an output C-PCR compound 114 before it is fed into the collection container 113, or may be positioned along an offshoot path 128 that receives a quantity of C-PCR pellets that are diverted from the main output of the processing machine 112. The inline spectrometer 121 continuously assesses spectral properties of an output C-PCR compound 114 and communicates signals conveying spectral properties the control unit 115 in real-time. The processor 117 uses signals received from the inline spectrometer 121 to determines L*a*b* color space values for coloration of the C-PCR pellets, continuously compares L*a*b* values of the C-PCR pellets to L*a*b* values of the intended target color for the C-PCR compound and continuously calculates a color-deviation ΔE between the two sets of L*a*b* values. If the color-deviation ΔE exceeds a predetermined color-deviation threshold ΔEp, the processor 117 uses stored L*a*b* color space data 126 to calculate a color correction for adjustment of the then current pigment recipe to alter metered quantities of the mono-masterbatches, natural PCR particles, or a combination of both, as needed to adjust coloration of the C-PCR compound 114 to be within acceptable bounds (i.e., to reduce color-deviation ΔE below the color-deviation threshold ΔEp).

The following is one example of an algorithm for generation of a pigment recipe for achieving a desired target color for varying base materials.
Step 1: the algorithm may begin with identifying a nominal starting recipe {C}={Ca, Cb, . . . , Cx}, where Ca, Cb, . . . , Cx are concentration percentages of each of the base mono-pigments. The starting recipe may correspond with a desired target color that may be identified as Lab0={L0,a0,b0}.
Step 2: Using any known color formulation algorithm(s) based on Kubelka-Munk, multi-flux, Lambert-Beer, or any other models [REF1], and using scattering and absorption spectral data K(λ) and S(λ) for the collection of mono-pigments in the system (the base pigments), calculate a nominal best-fit recipe {C0} from the Lab0 color coordinates. For this calculation a “standard” (nominal) color of the raw PCR particles is assumed, for example, such as the color for a pure virgin resin.
Step 3: Manufacture PCR compound based on the current recipe and measure the resulting color coordinates Lab1={L1,a1,b1} of the manufactured PCR compound by the in-line spectrometer 121.
Step 4: A pigment recipe of the measured color of the produced PCR compound is reverse calculated by the same method and input parameters as used in Step 1, resulting in a pigment recipe {C1} for the currently produced PCR compound.
Step 5: The recipe is corrected to yield a new recipe {Cnew} for producing the desired target color closest to Lab0, the new recipe being represented as:

$$\{ Cnew \} = \{ C \} + ( \{ C 0 \} - \{ C 1 \} ) .$$

Steps 2 to 4 are repeated continuously with the new recipe {Cnew} replacing and serving as the starting recipe {C} in subsequent iterations to account for PCR color variations. As to Step 1, models for suitable color formulation algorithms may include, for example, those provided by Berns, R., (2019), Billmeyer and Saltzman's Principles of Color Technology, DOI: 10.1002/9781119367314.

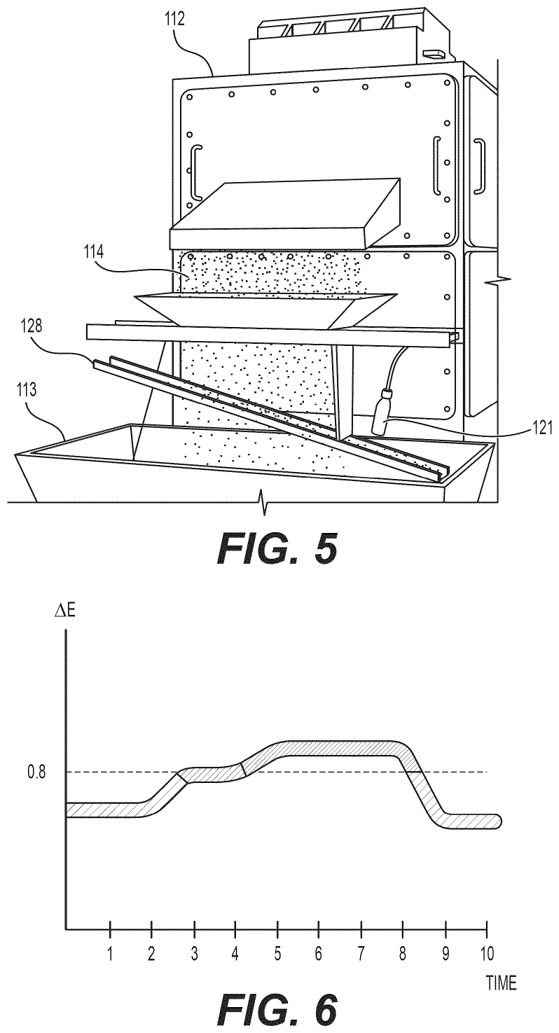

FIG. 6 shows calculations of the processor 117 in monitoring and correcting coloration of a C-PCR compound 114 in real-time. In a time period T1-T3, a color-deviation ΔE between the C-PCR compound and the target color is below a predetermined color-deviation threshold ΔEp (ΔEp=0.8), and the control unit 115 therefore continues operation with the then current pigment recipe. In a time period T3-T4, the color-deviation ΔE is equal to the color-deviation threshold ΔEp. In this example, no action is taken as the control unit 115 is programmed to effect a color correction only when the color-deviation ΔE exceeds the color-deviation threshold ΔEp (ΔE>ΔEp), though in other examples the control unit 115 may be programmed to begin color corrections when the color-deviation ΔE is equal to or in excess of the color-deviation threshold ΔEp (ΔE>ΔEp). At a time T4, the color-deviation ΔE exceeds the color-deviation threshold ΔEp, and the control unit 115 begins color correction by calculating a recipe correction {C0}-{C1} for updating the then current pigment recipe in a manner determined to alter coloration of the C-PCR compound 114 to effectively reduce the color-deviation ΔE. In a time period T4-T8, the control unit 115 continues color correction by repeatedly recalculating and updating the pigment recipe with color recipe corrections {C0}-{C1} that continually alter coloration of the C-PCR compound 114 to reduce the color-deviation ΔE. At a time T8, the color-deviation ΔE is effectively reduced to a value below the color-deviation threshold ΔEp, and the control unit 115 therefore ceases color correction and continues operation with the then current pigment recipe that resulted from the most recent color correction. In this way, the control unit 115 continually monitors and adjusts coloration of the C-PCR compound in real-time.

Data informing the intended target color for a given C-PCR compound 114 is be stored in the memory 116 of the control unit 115. The target color data may be stored as L*a*b* color space data 126 and associated with one or more corresponding pigment recipes 125—for example, with different pigment recipes available for achieving an individual target color based on the use of different polymer components. Control unit 115 may be configured for a user to interact with the user interface 122 to identify a polymer component (e.g., a PCR particle type or source) that is to be used in a production run and a target color for the C-PCR compound to be produced from the production run, with the control unit 115 then identifying an appropriate pigment recipe for achieving the selected target color. Optionally, the system 100 may also include a sampling cabinet 129 with a sampling spectrometer 130 and a reception space (internal) for insertion of a physical reference sample that may be positioned proximate the sampling spectrometer 130. Optionally, the physical reference sample may be a prior produced product with a desired color for matching by the C-PCR compound 114, or a sampling array containing multiple color samples. The sampling spectrometer 130 may scan the sample reference and deliver spectral signals conveying coloration of the reference sample to the control unit 115, which may then use those signals to determine L*a*b* color space values informing a coloration of the reference sample for use in selecting or calculating a pigment recipe for producing a C-PCR compound 114 with coloration matching that of the reference sample color.

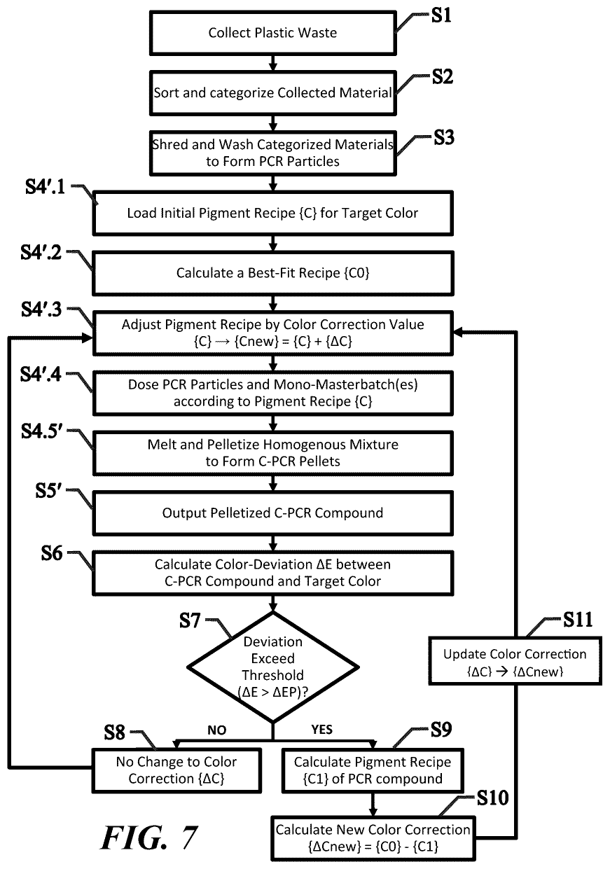

FIG. 7 shows a process for forming a C-PCR compound 114 according to the present invention. In this example, the process begins with conventional steps of collecting plastic waste (S1), sorting and categorizing the collected material (S2), shredding and washing the categorized materials to produce PCR particles (S3). These steps S1-S3 may optionally be substituted by any other suitable means for obtaining PCR particles.

Once the PCR particles are loaded into a single-component supply source 101a of the system 100, the control unit 115 loads a nominal (initial) pigment recipe {C} for production of a C-PCR compound 114 with a selected target color coordinates (for example, in L*a*b* or any other space) (S4′.1, Algorithm Step 1). The nominal pigment recipe {C} provides precise dosing instructions for the raw PCR particles and the mono-masterbatches based on a presumption for the composition of the raw PCR particles at use in that instance. That is, the nominal pigment recipe {C} represents an attempt at providing a recipe that most accurately yields the desired target color based on the expected nature of the raw PCR particles. The control unit 115 may select the pigment recipe {C} based on inputs from a user, for example, by using the user interface 122 to select a desired target color and identifying a PCR type or source as the polymer component. It is preferrable that the nominal recipe {C} be one that uses some appreciable amount of each of the available mono-masterbatches, as this enables greater flexibility in effecting future adjustments of the recipe by permitting either and increases or decreases in the quantities of each available mono-masterbatch.

Control unit 115 then calculates a best-fit recipe {C0} providing precise dosing instructions for a standard polymer component and mono-masterbatches for achieving the target color (S4′.2, Algorithm Step 2). This best-fit recipe {C0} is formulated on the presumption that the standard polymer component has a known, standard color as a starting point for adjustment by the pigments of the mono-masterbatches. Any suitable standard color may be presumed for this purpose (e.g., a translucent color).

The control unit 115 then checks for any color correction that is to be made to the nominal pigment recipe {C} (S4′.3). When a color correction ΔC is available, the nominal pigment recipe is updated ({C}→{Cnew}) by adding the color correction ΔC to the nominal pigment recipe {C}. This correction is achieved by altering the instructed quantities of individual mono-masterbatches as provided in the nominal recipe {C} based on the differences provided by the color correction ΔC. At the beginning of a production run, in the absence of any relevant color correction algorithms from prior production runs for production of a similar C-PCR compound from similar raw PCR particles, the color correction will be set to a zero value, with no correction made to the initial pigment recipe at that time.

The control unit 115 next instructs the material feeders 102 to feed PCR particles and mono-masterbatches according to the then current nominal pigment recipe {C}—i.e., the recipe as updated by any current color correction (S4′.3, Algorithm Step 3). In a system 100 such as that shown in FIG. 3A, this step may be achieved by simply feeding the combined material feeds to the processing machine 112, either directly or through a funnel 30. In a system 100 such as that shown in FIG. 3B, this step may include further steps of collecting and weighing the combined quantities of PCR particles and mono-masterbatches in the weighing receptacle 106, then feeding the combined quantities to the mixing chamber 109 in an appropriate weight for creation of a homogenous mixture that is then fed to the processing machine 112. Once received in the processing machine 112, the combined component feeds are heated, melted, ectruded and pelletized to produce C-PCR pellets (S4′.5) that are then output as a C-PCR compound 114 (S5′).

As the C-PCR compound 114 is output from the processing machine 112, spectral properties of the C-PCR pellets are analyzed by the inline spectrometer 121 in communication with the control unit 115 for calculation of a color-deviation ΔE between the color of the C-PCR pellets and the target color (S6, Algorithm Step 3). A determination is then made as to whether the calculated color-deviation ΔE exceeds a color-deviation threshold ΔEp (S7). If the color-deviation ΔE does not exceed the color-deviation threshold ΔEp (“NO”), the control unit 115 determines that no change is needed to the color correction ΔC (S8), and subsequent production runs are continued with the then current color correction ΔC (S4′.3). If the color-deviation ΔE exceeds the color-deviation threshold ΔEp (“YES”), the control unit 115 updates the color correction ΔC (S9-S11) by calculating a new color correction for adjusting coloration of the C-PCR compound 114 to effectively reduce the color-deviation ΔE (Algorithm Step 4).

When updating the color correction ΔC, the control unit 115 first calculates a product recipe {C1} that would be effective for producing the C-PCR compound that was output by the processing machine 112 with the color as analyzed by the in-line spectrometer 112 (S9). The control unit 115 calculates the product recipe {C1} via reverse application of the method and input parameters that were used for calculating the best-fit recipe {C0}. The control unit 115 then calculates a new color correction ΔCnew by determining differences between the best-fit recipe {C0} and the product recipe {C1} (S10), The color correction ΔC is then replaced by the newly calculated color correction ΔCnew (S11), and this new color correction ΔC is stored for use in subsequent production runs (S4′.3).

The production run the continues with subsequent batches commencing with adjustment of the pigment recipe {C} by the then current color correction ΔC (S4′.3), with that adjusted pigment recipe {C} used for metering the material components for production of the next batch of C-PCR compound 114. The production run for subsequent batches of C-PCR compound continues repetitively (S4′.3)-(S11), with the pigment recipe {C} repeatedly updated by newly calculated color corrections ΔC, as needed, until the production run is complete or otherwise terminated. It is noted that the predetermined color-deviation threshold ΔEp may be set to any desired value based on the needs for the C-PCR compound that is to be produced in any given production run. This may include, for example, setting a threshold value of approximately or exactly 0.0, such that the color correction ΔC is continuously updated throughout the entire production run such that coloration of the C-PCR compound is finely controlled in real-time throughout the entire production run.

Systems and methods according to the present invention use real-time color monitoring and automated color correction to produce C-PCR compounds that reliably achieve a target color with minimal color-deviation, which is expected to significantly improve manufacturing of colored, PCR-based plastic products. Plastics manufacturers that use C-PCR compounds produced from the inventive systems and methods will be able to select a pigment recipe for achieving a desired target color, with the selected pigment recipe being formulated based on the manufactured base-color of the C-PCR compound. Because the C-PCR compound has a substantially uniform color, unlike uncolored PCR particles that have a grayish color distribution of varying gray and black shades, there will be significantly less color variation in plastic products produced with these C-PCR compounds.

It is further expected that systems and methods according to the present invention facilitate the production C-PCR compounds with highly accurate color distributions, as the use of material supply sources containing mono-masterbatches of single pigment compositions enables the system to make precise corrections to color through minute, incremental changes in the L*a*b* color space for efficiently adjusting the pigment recipe to reduce detected color-deviations. It is expected that production of a C-PCR compound from individual mono-pigment masterbatches, with the capability of minutely adjusting metering quantities of each mono-pigment masterbatch, enables color adjustments with an efficiency that could not otherwise be achieved through use of premixed multi-pigment masterbatches, such as those conventionally used in the production of plastic products.

While the foregoing discussion address the inventive systems and methods in the context of producing colored PCR pellets for use as the polymer component in the manufacture of plastic products, it will be understood that systems and methods according to the present invention may also be used to produce colored PCR pellets for use as pigment and/or additive masterbatches, with the PCR particles, pigments and/or additives metered in corresponding quantities such that the PCR plastic serves as a carrier resin within which the pigments and/or additives are encapsulated.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

To the extent necessary to understand or complete the disclosure of the present invention, all publications, patents, and patent applications mentioned herein are expressly incorporated by reference herein to the same extent as though each were individually so incorporated. No license, express or implied, is granted to any patent incorporated or otherwise referenced herein.

The present invention is not limited to the exemplary embodiments illustrated herein, but is instead characterized by the appended claims, which in no way limit the scope of the disclosure.

1. A system for production of colored post-consumer recycled (PCR) compound, comprising:
a plurality of material feeders, each adapted for feeding metered quantities of a corresponding material;
a control unit configured to control operation of the plurality of material feeders to feed the corresponding materials at predetermined feed rates in accord with a pigment recipe that is formulated for producing colored PCR compound of a target color from a number of mono-piment masterbatches; and
a spectrometer in signal communication with the control unit for delivering spectral signals to the control unit informing on the color of colored PCR compound,
wherein the control unit is configured to:
(a) calculate a color-deviation between the color of the colored PCR compound and a target color associated with a pigment recipe that the control unit is using to control the material feeders for production of colored PCR compound, and to determine if the calculated color-deviation exceeds a predetermined color-deviation threshold; wherein
(i) if the calculated color-deviation exceeds the color-deviation threshold, calculate a color correction for adjusting the pigment recipe to alter feed rates of one or more of the plurality of material feeders to reduce the calculated color-deviation, adjust the pigment recipe in accord with the calculated color correction, and proceed with control of the material feeders in accord with the adjusted pigment recipe; and
(ii) if the calculated color-deviation does not exceed the color-deviation threshold, proceed with control of the material feeders without adjustment to the pigment recipe.

2. The system according to claim 1, wherein:
the control unit is configured to control the material feeders in accord with a pigment recipe {C} that is formulated for producing the colored PCR compound from uncolored PCR particles, the control unit being configured to adjust the pigment recipe {C} in real-time based on a color correction (ΔC) that is calculated from spectral property differences between a best-fit pigment recipe for the target color {C0} that is formulated in advance based on a presumed baseline color for the uncolored PCR particles, and a resultant pigment recipe {C1} that is calculated in real-time based on spectral properties of color PCR compound produced according to the pigment recipe {C}.

3. The system according to claim 1, wherein:
the control unit is configured to control the material feeders for feeding predetermined quantities of PCR particles and a number of mono-pigment masterbatches into a processing machine for melting and pelletizing the combined materials to form colored PCR compound; and
the spectrometer is configured to monitor spectral properties of PCR compound output from a processing machine that receives the combined materials for forming the colored PCR compound.

4. The system according to claim 1, further comprising:
a processing machine configured to receive the combined materials that are fed from the material feeders under control of the control unit, and to melt and pelletize the combined materials to form colored PCR pellets, and to output the colored PCR pellets for collection as a colored PCR compound.

5. The system according to claim 1, wherein
the spectrometer is positioned proximate an outlet of the processing machine for assessing spectral properties of colored PCR pellets output from the processing machine.

6. The system according to claim 1, wherein
the control unit is configured to receive a user input identifying a target color and to load a pigment recipe for producing a colored PCR compound with the target color.

7. The system according to claim 1, wherein
the control unit comprises a memory storing one or more pigment recipes, and the control unit loads the pigment recipe for producing the colored PCR compound with the target color by identifying a pigment recipe stored in the memory and associated with the target color.

8. The system according to claim 1, wherein
the control unit comprises a memory storing L*a*b* color space data, and the control unit loads the pigment recipe for producing the colored PCR compound with the target color by calculating a pigment recipe for the target color using the stored L*a*b* color space data.

9. The system according to claim 1, wherein
the control unit is configured to execute the controls at (a)(i)-(a)(ii) in real-time.

10. The system according to claim 1, wherein
the control unit is configured to repeatedly adjust a pigment recipe multiple times during a single production run for decreasing a calculated color-deviation each time the calculated color-deviation exceeds a predetermined color-deviation threshold.

11. A method of producing colored PCR compound, comprising:
controlling a system according to claim 1 to feed PCR particles from at least one material feeder and to feed one or more mono-pigment masterbatches from one or more further material feeders.

12. The method according to claim 11, further comprising:
controlling the system to execute the controls at (a)(i)-(a)(ii) in real-time.

13. The method according to claim 11, further comprising:
loading a pigment recipe for producing colored PCR compound with a target color that is selected by a user operating the system.

14. The method according to claim 11, wherein:
the pigment recipe for producing the colored PCR compound with the target color is loaded from a memory of the control unit.

15. The method according to claim 11, wherein:
the pigment recipe for producing the colored PCR compound with the target color is loaded by calculating a pigment recipe for the target color using L*a*b* color space data stored in a memory of the control unit.
